(19) United States
(12) Patent Application Publication
(10) Pub. No.: US 2008/0210582 A1
(43) Pub. Date: Sep. 4, 2008

(54) INHIBITION OF PAINT-PRODUCT SKIN FORMATION

(75) Inventors: Donald Lee Betz, Avon Lake, OH (US); James Michael Cameron, Brunswick, OH (US); Norbert Erwin Graff, Lakewood, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/039,958

(22) Filed: Feb. 29, 2008

Related U.S. Application Data
(60) Provisional application No. 60/892,685, filed on Mar. 2, 2007.

(51) Int. Cl. C09D 7/04; B65D 81/24; B65B 55/22; B65B 3/04; B05D 5/00

(52) U.S. Cl. 206/205; 427/154; 220/578; 53/431

(57) ABSTRACT

Paint in a container is inhibited against skinning by providing a layer of a barrier material comprising an inhibiting composition having a boiling point of at least 250° C. and optionally water on the upper surface the bulk paint in the container.

### CROSS-REFERENCE TO RELATED APPLICATIONS

This application claims the benefit of U.S. Provisional Application No. 60/892,685 filed Mar. 2, 2007 the entirety of which is hereby incorporated by reference.

### BACKGROUND

The formation of insoluble films on the interior surfaces of the lid and exposed wall surfaces of a paint container filled with paint is commonly referred to as “skinning.” The present invention relates to a composition and method for inhibiting the formation of such paint product skin inside a paint container.

### BRIEF DESCRIPTION OF THE DRAWINGS

FIG. 1 illustrates an embodiment of a container useful in connection with the present invention.

FIG. 2 illustrates an embodiment of a container useful in connection with the present invention.

### DETAILED DESCRIPTION OF THE INVENTION

Skinning in paint containers is believed to result from temperature differences between the bulk paint in the container and paint that splashes onto the lid and/or non-submerged interior walls of the container. Because the thermal heat capacity of the paint/lid combination is less than the heat capacity of the bulk paint/container combination, temperature differences will occur as the ambient temperature changes. Skinning may be a part of the drying process caused by the transfer of moisture from liquid paint adhering to the non-submerged surfaces of the paint container (e.g. lid and/or non-submerged walls of the container) to the bulk paint as a result of these temperature differences. Without being limited to any particular theory, it is believed that the present invention minimizes skin formation in a filled container of paint by slowing down the water transfer rate between the lid and exposed wall surfaces and the bulk paint when temperature gradients are present and/or serving as a barrier to minimize paint splashing onto the interior surfaces.

The present invention comprises a method and composition for preventing skin formation on the interior surfaces of the lid and exposed interior wall surfaces of a vessel filled with paint. The method of the present invention comprises delivering a paint composition to a vessel closeable at its top with a lid and delivering a sufficient quantity of a barrier material comprising a skin formation inhibiting composition to the open vessel to provide a layer of the barrier material, which substantially covers the top surface of the paint composition. Delivery of the barrier material can be accomplished prior to, simultaneously with, or after delivery of the paint composition to the vessel. In one useful embodiment, the barrier material is delivered to the vessel after delivery of the paint composition is completed. The delivery of liquid materials to the vessel can be accomplished by hand or by the addition of a barrier material delivery means to apparatus already appropriate for vessel filling as is known in the art. Examples of delivery means include shower head or faucet type dispensing means such as those illustrated in U.S. Pat. No. 5,911,257 which is hereby incorporated by reference. After the barrier material is added to the container, the container is closed without intentionally mixing the barrier material into the paint composition so as to maintain a floating layer of barrier material on the upper surface of the latex paint.

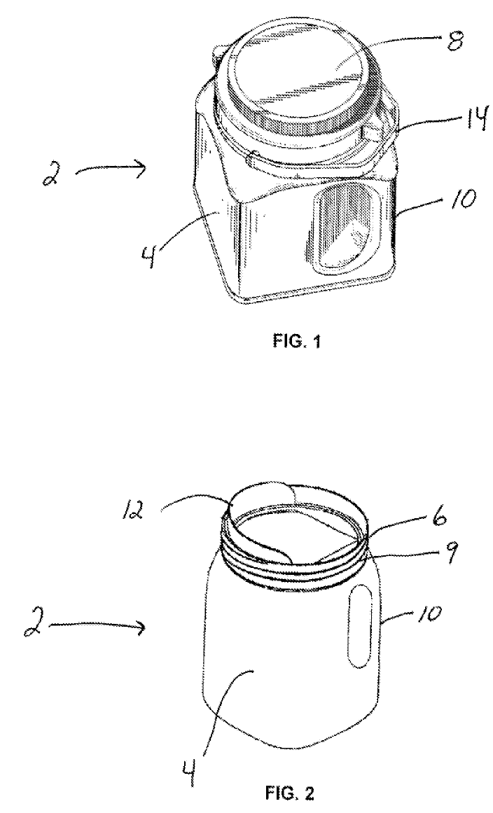

Vessels employed to house paint compositions are known. In one embodiment, suitable vessels have a lid that securely closes the vessel. Paint vessels include metal cans as are known in the art. Such metal cans are typically cylindrical and are available in various sizes to hold different volumes of paint, such as quarts and gallons. In recent years, plastic paint containers have been introduced to the industry. Such plastic paint containers are disclosed in U.S. Pat. Nos. 6,530,500 and 6,983,862, which are incorporated herein by reference. In addition, FIGS. 1 and 2 illustrate embodiments of such plastic paint containers. Such containers may comprise a container 2 with one or more sidewalls 4, for example four sidewalls. The containers may also comprise a neck 6 defining a container opening, which may be a wide-mouth opening, which mates with a lid 8. The neck may comprise threads 9 to mate with threads on the lid. The container may also have an integral handle 10 for lifting the container. In addition, in one useful embodiment, the container may have a spout 12. The spout 12 may be molded into the container neck 6 or may a separate piece added as an insert to the container. The lid 8 for such containers may be flat or may have a stepped surface such as the lid shown in FIG. 1 or in FIGS. 8a-8c of U.S. Pat. No. 6,983,862, which are incorporated by reference. In some embodiments, such paint containers may also include a bail handle 14. Plastic containers as discussed herein may be in various sizes including gallon and quart sizes and usually have an effective packing footprint similar to conventional metal paint cans.

The present invention also comprises a paint container containing a quantity of paint having and the barrier material of the present invention. In one embodiment of the invention, the barrier material floats on a substantial portion of the top surface of the bulk paint in the container. In one useful embodiment, the layer of barrier material is maintained as a distinct layer on the top of the paint and intentionally is not mixed with the paint. However, some mixing of the barrier material with the paint during normal movement of the paint containers.

A sufficient amount of the barrier material may be used to minimize or prevent skin formation by the paint during normal storing and transit activities. In one embodiment, about 0.4 ounce to about 8 ounces of the barrier material may be used, including but not limited to about 0.5, about 0.75, about 1, about 1.5, about 2, about 3, about 4, about 5, about 6, and about 7 ounces. For example, about 0.75 ounces may be appropriate for a quart container, about 2 ounces of barrier material may be appropriate for a one gallon container, while about 6 ounces of barrier material may be appropriate for a 5 gallon container. However, other amounts may be used as appropriate for the type and handling of a particular container. The barrier material may have a thickness of about 1/16 of an inch to about ½ inch, for example about ⅛ inch, further for example about ¼ inch.

The present invention is discussed as being useful in connection with latex paints. Such paints typically are air-drying aqueous coatings containing the organic polymeric binder, pigments and various known paint additives. The polymeric binders are typically prepared by emulsion polymerization and include for example, acrylic latexes including but not limited to vinyl acrylic and styrene acrylic and ethylene vinyl acetate copolymers (EVA or VAE). The present invention may also be useful with other types of paints where skinning may be an issue.

In one embodiment of the invention, the barrier material may comprise an inhibiting composition that is less dense than the paint composition and is sufficiently compatible with the paint composition to produce substantially no detrimental effects when mixed with the paint composition. It is useful for the barrier material and/or inhibiting composition to have lower volatility than the volatile portion of the paint being protected. For example, the barrier material may be used in connection with a latex paint wherein the volatile component typically comprises water and/or organic solvent.

The barrier material may comprise one or more inhibiting compounds that have a boiling point of at least about 250° C. or greater than about 250° C. at standard atmospheric pressure (760 mmHg). In one embodiment, the barrier material may comprise one or more inhibiting compounds that have a boiling point of at least or greater than about 250° C., for example, at least or greater than about 260° C., and further for example, at least or greater than about 280° C., and even further for example, at least or greater than about 285° C. In an alternative embodiment, the barrier material may comprise one or more inhibiting compounds that are solids at room temperature. Such high boiling compounds or solids are typically considered to be compliant with new more stringent standards relating to the content of volatile organic compounds (VOC) in paint compositions. Several of the inhibiting compositions mentioned herein are considered to have low or no VOC content.

In one embodiment, the barrier material may comprise one or more polyhydric polyols that have a boiling point of at least or greater than about 250° C., for example, at least or greater than about 260° C., and further for example, at least or greater than about 280° C., and even further for example, at least or greater than about 285° C. Examples of useful polyols having boiling points of at least about 250° C. including but are not limited to polyethylene glycol (Average molecular weight of at least 200), pentaerythritol, trimethylol ethane, trimethylol propane, glycerin, sorbitol, and triethanol ethane. In one embodiment, the barrier material may comprise a mixture of the high boiling polyols with water. Mixtures useful for inhibiting skin formation comprise mixtures of about 12.5% polyol with water up to 100% polyol alone. For example, in one embodiment of the invention, about 12.5% to about 75% by volume polyol may be mixed with water. Such mixtures may include about 25% polyol, about 37.5% polyol, and about 50% polyol, with the remainder of the mixture being water. In one embodiment, the mixtures are prepared mixing the components by volume. However, it is contemplated by the present invention that the barrier material can be prepared by mixing the components by weight as well.

In one useful embodiment of the invention, the barrier material comprises a mixture of glycerin with water wherein the glycerin comprises from about 12.5% glycerin up to about 75% glycerin (by volume). Such mixtures may include about 25% glycerin, about 37.5% glycerin, and about 50% glycerin.

In another useful embodiment, polyethylene glycol having a molecular mass of about 200 to about 600 may be useful. Such polyethylene glycols may be mixed with water up to about 50% by volume. In another embodiment, solids such as sorbitol, triethanol ethane, trimethylol propane, pentaerythritol, and trimethylol ethane dissolved in water may be useful. For example, these polyols may be mixed at about 10%, about 25%, or about 50% by weight with water may be used. In addition, various other water soluble polyhydric alcohols may also be useful in the present invention.

Another example of a compound useful as or as part of a barrier material is mineral oil. In some cases, mineral oil may be used alone or in combination with other materials as a defoamer in paint compositions. The mineral oil or mineral oil based defoamer may be used alone or mixed with up to about 50% by weight water, for example about 10% or about 25% by weight. In another useful embodiment, alcoholic amines, such as triethanol amine may be useful. The triethanol amine may be mixed with water to be used in a barrier material. Other commercially available additives may also be useful such as humectants or paint conditioners such as Humectant GRB2 available from Noveon or FLOETROL® paint conditioner available from Flood. Such additives may be mixed with up to 50% by volume water to be used as a barrier material in a paint container.

In another useful embodiment, the barrier material may contain a preservative composition. The preservative may be present in an effective amount to prevent, reduce or minimize bacterial and/or fungal growth in the paint or within the barrier material itself. Useful preservatives include but are not limited to bronopol (2-bromo-2-nitro-1,3-propanediol), glutaraldehyde, 5-chloro-2-methyl-4-isothiazolin-3-one/2-methyl-4-isothiazolin-3-one, 1,2-benzisothiazolin-3-one, 1-(3-chloroallyl)-3,5,7-triaza-1-azoniaadamantane chloride, hexahydro-1,3,5-tris(2-hydroxyethyl)-s-triazine, polyaminopropyl biguanide, and mixtures of the foregoing. Preservatives may be included in the barrier material at amounts such as up to about 10,000 ppm. As another example, the preservative may be included as amounts such as up to about 1%. Various preservative materials are commercially available such as DOWICIL 75 from Dow Chemical, KATHON CGICP and CGICP-II from Rohm & Haas, PROXEL GXL, TRIADINE 174, REPUTAIN B30 and K50, and VANTOCIL IB all from Arch Chemical.

In preparing the barrier materials for the present invention, the components could be mixed by simply stirring or by using equipment such as a high speed disperser or a thindown tank. The barrier material may be prepared by adding water, the skin-inhibiting material, such as glycerin, and the biocide in any order and mixing the components together. In some embodiments, it may be useful to mix the biocide and water first before adding the skin-inhibiting material to the mixture.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A method of inhibiting non-dispersible paint skin formation on non-submerged surfaces of a container containing paint, wherein the paint has an upper surface exposed to air within the container, comprising:
(a) providing a barrier material comprising an inhibiting composition having a boiling point of at least about 250° C.;
(b) disposing a layer of the barrier material over the upper exposed surface of the paint in the container to provide a layer of barrier material which floats on a substantial portion of the upper surface of the paint;
(c) closing the container while maintaining the layer of barrier material on the upper surface of the paint.

2. The method of claim 1, wherein the inhibiting composition comprises a polyol having a boiling point of at least about 250° C.

3. The method of claim 2, wherein the inhibiting composition is selected from polyethylene glycol, glycerin, sorbitol, trimethylol ethane, triethanol ethane, trimethylol propane, and pentaerythritol.

4. The method of claim 3, wherein the barrier material further comprises water.

5. The method of claim 1, wherein the inhibiting composition comprises mineral oil.

6. The method of claim 1, wherein the inhibiting composition is glycerin and the barrier material further comprises water.

7. The method of claim 6 wherein the barrier material comprises about 12.5% to about 75% by volume glycerin.

8. The method of claim 7 wherein the barrier material comprises about 50% by volume glycerin.

9. The method of claim 7 wherein the barrier material comprises about 37.5% by volume glycerin.

10. The method of claim 1 wherein the inhibiting composition comprises triethanol amine.

11. The method of claim 1 wherein disposing a layer of the barrier material over the upper exposed surface of the paint comprises disposing about 0.4 to about 8 ounces of barrier material.

12. The method of claim 1 wherein disposing a layer of the aqueous glycerin mixture over the upper exposed surface of the paint comprises disposing about 2 to about 6 ounces of barrier material.

13. The method of claim 1 wherein the barrier material comprises a preservative.

14. The method of claim 13 wherein the preservative is selected from 2-bromo-2-nitro-1,3-propanediol, glutaraldehyde, 5-chloro-2-methyl-4-isothiazolin-3-one/2-methyl-4-isothiazolin-3-one, 1,2-benzisothiazolin-3-one, 1-(3-chloroallyl)-3,5,7-triaza-1-azoniaadamantane chloride, hexahydro-1,3,5-tris(2-hydroxyethyl)-s-triazine, polyaminopropyl biguanide, and mixtures thereof.

15. A method of inhibiting non-dispersible, water insoluble, paint skin formation on non-submerged surfaces of a container containing paint, wherein the filled paint has an upper surface exposed to air within the container comprising:
(a) delivering a paint composition to an open upright plastic container comprising a body having a bottom, at least four sidewalls and a neck, wherein said neck includes threads for receiving mating threads on a lid, said container body comprising an integral handle for lifting said container;
(b) delivering a sufficient amount of a no VOC barrier material to the open upright plastic container to provide a layer of barrier material which substantially covers a top surface of the paint composition;
(c) closing the container with a lid comprising threads to match the threads on the container neck.

16. The method of claim 15 wherein the barrier material comprises one or more of polyethylene glycol, glycerin, sorbitol, trimethylol ethane, triethanol ethane, pentaerythritol, trimethylol propane, triethanol amine, and mineral oil.

17. The method of claim 16 wherein the barrier material further comprises water.

18. The method of claim 15 wherein the barrier material further comprises a preservative.

19. The method of claim 15 wherein the barrier material is delivered to the open container after the paint composition is delivered to the container.

20. A paint container comprising:
(a) a container a lid assembly;
(b) a paint composition in said container, wherein said paint composition has a top surface;
(c) a barrier material comprising an inhibiting composition having a boiling point of at least 250° C. positioned as a layer on said top surface of said paint composition.

21. The paint container of claim 20, wherein the barrier material comprises one or more of polyethylene glycol, glycerin, sorbitol, trimethylol ethane, triethanol ethane, pentaerythritol, trimethylol propane, triethanol amine, and mineral oil.

22. The paint container of claim 21, wherein the barrier material further comprises water.

23. The paint container of claim 20 wherein the barrier material comprises a mixture of glycerin and water.

24. The paint container of claim 23 wherein the barrier material comprises about 12.5% to about 75% by volume glycerin.

25. The paint container of claim 24 wherein the barrier material comprises about 50% by volume glycerin.

26. The paint container of claim 24 wherein the barrier material comprises about 37.5% by volume glycerin.

27. The paint container of claim 20 wherein about 0.4 to about 8 ounces of barrier material is positioned as a layer on the top surface of the paint composition.

28. The paint container of claim 27 wherein about 2 to about 6 ounces of barrier material is positioned as a layer on the top surface of the paint composition.

29. The paint container of claim 20 wherein the barrier material comprises a preservative.

30. The paint container of claim 29 wherein the preservative is selected from 2-bromo-2-nitro-1,3-propanediol, glutaraldehyde, 5-chloro-2-methyl-4-isothiazolin-3-one/2-methyl-4-isothiazolin-3-one, 1,2-benzisothiazolin-3-one, 1-(3-chloroallyl)-3,5,7-triaza-1-azoniaadamantane chloride, hexahydro-1,3,5-tris(2-hydroxyethyl)-s-triazine, polyaminopropyl biguanide, and mixtures thereof.

31. The paint container of claim 20, the container and lid assembly further comprising a container having a body with a bottom wall, four sidewalls and a neck; said neck defining a wide mouth opening and including threads for receiving mating threads on said lid, said body having an integral handle for lifting said container.
